(19) United States
(12) Patent Application Publication
(10) Pub. No.: US 2018/0365956 A1
(43) Pub. Date: Dec. 20, 2018

(54) Blue Bird Car Seat Alarm

(71) Applicant: Andrew Garth Wilson, Lithia, FL (US)

(72) Inventor: Andrew Garth Wilson, Lithia, FL (US)

(21) Appl. No.: 15/626,146

(22) Filed: Jul. 24, 2017

(30) Foreign Application Priority Data
Jun. 18, 2017 (US) 15626146

(51) Int. Cl. G08B 21/02; B60Q 9/00

(52) U.S. Cl. CPC G08B 21/0266; B60Q 9/00

(57) ABSTRACT

The present invention provides a way to alert the driver when a child is left unattended in the car seat. The invention uses short-range wireless technology (eg Bluetooth) to trigger an alarm when the paired device goes beyond a defined perimeter. The paired device is a key FOB or a smartphone application. The invention has two sides. Each side is attached to the two buckle inserts of the standard car seat belt harness. Closure of the buckle causes both sides of the invention to make contact, which turns on/arms the invention. When armed, and the paired device goes beyond a defined range i.e. the driver walks away from the car, an alert on the paired device will be activated.

### TECHNICAL FIELD

The present invention provides a way to alert the driver when a child is left unattended in the car seat. The invention uses short-range wireless technology (eg Bluetooth) to trigger an alarm when the paired device goes beyond a defined perimeter. The paired device is a key FOB or a smartphone application.

### DISCLOSURE OF INVENTION

The invention has two sides. Each side is affixed to the standard car seat buckle via the seat belt strap just above the two buckle inserts. See FIG. 6. The invention is turned on when the seat buckle is closed. Closure of the buckle forces both sides of the invention to come in close contact or direct contact with each other. This action turns on/arms the invention. In the illustration shown (FIG. 2) the thin curved strip comes into contact with the opposite flat surface causing the invention to switch on.

Once the Blue Bird Alarm is on it will chirp and verbally confirm it is paired and ready. The alarm will only sound if the seat belt remains buckled and the FOB or paired phone app goes beyond a defined perimeter or out of range. If Bluetooth Class 2 technology is used this range will be approximately 10 meters.

### ADVANTAGES

The Blue Bird Alarm does not require the driver to do anything different or break his or her routine. The alarm is turned on when the buckle is closed and is turned off when the buckle is open.
The invention is turned on only when needed. When no child is secure in the car seat the invention will remain off—saving battery power.
The perimeter trigger allows the driver to operate in and around the car without sounding the alarm. For instance, refueling at the gas pump will not cause the alarm to be triggered.
The invention is not triggered by temperature and as such will be effective in preventing hot car deaths AND dangers associated with leaving a child unattended in cool or cold temperatures.
The invention is not triggered by weight as such premature infants with low birth weight will also be protected.

### SPECIFICATION EXAMPLE

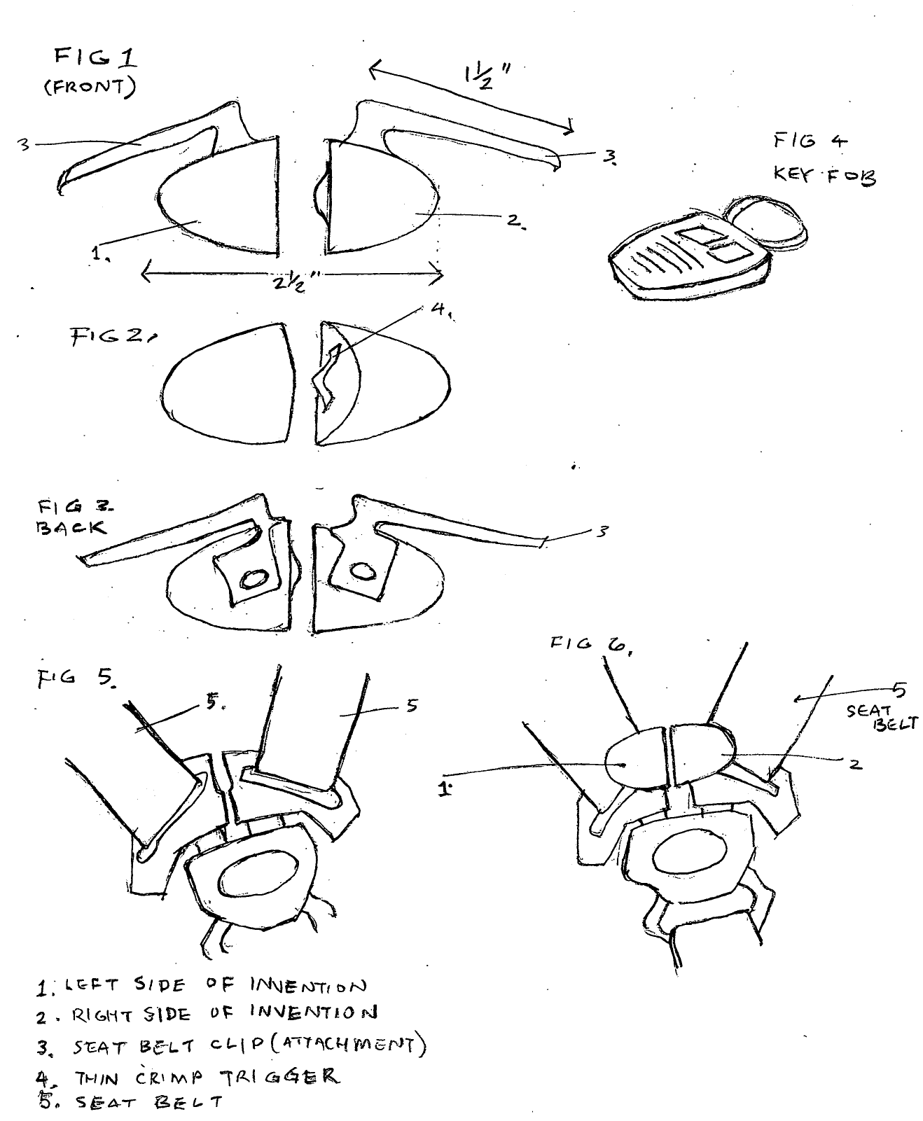

FIG. 1: Front view illustration of invention in open position.

FIG. 2: Angle view of the invention showing the contact/trigger.

FIG. 3: Back side of invention showing the clip arms that attach to seat belt

FIG. 4: Key FOB

FIG. 5: Closed buckle w/out invention

FIG. 6: Closed buckle with activated invention.

1. A car seat invention applying short range wireless technology (eg. Bluetooth) to trigger an alarm and or an alert when the paired device goes beyond a certain distance.

2. A car seat alarm of claim 1 characterized in that the paired device is a smart phone application or a key FOB.

3. The invention as claimed in claim 1 is characterized in that it can be attached to existing car seat belt strap/harnesses.

4. The invention as claimed in claim 1 is characterized in that it comprises of two sides, each of which is affixed above the two seatbelt buckle inserts.

5. The invention as claimed in claim 1 is characterized in that closure of the buckle causes both sides to make contact which turns on/arms the invention.

6. The invention as claimed in claim 1 is characterized in that it is turned off when the seat belt buckle is released and both sides of the invention are separated.

7. The invention as claimed in claim 2 is characterized in that the alarm and or alert sounds on the paired device.
